(19) United States
(12) Patent Application Publication
(10) Pub. No.: US 2003/0147473 A1
(43) Pub. Date: Aug. 7, 2003

(54) Digital signal transmitting device for switching a signal processor of a fault condition for a spare signal processor of a non-fault condition

(75) Inventor: Toshihisa Ozu, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: MITSUBISHI DENKI KABUSHIKI KAISHA, Tokyo (JP)

(21) Appl. No.: 10/206,218

(22) Filed: Jul. 29, 2002

(30) Foreign Application Priority Data
Feb. 6, 2002 (JP) 2002-029787

(51) Int. Cl. H04L 27/04

(52) U.S. Cl. 375/295

(57) ABSTRACT

A plurality of signal processors and a plurality of spare signal processors are respectively formed of a card so as to be disposed on substrates different from each other. A type of signal processing is performed for a plurality of digital signals of a primary group digital signal in the signal processors, and a primary group processed digital signal obtained from a plurality of processed digital signals is sent out. When a fault occurs in a specific signal processor, the specific signal processor of a fault condition is detected in a system monitoring and controlling unit, the specific signal processor is switched for one spare signal processor of a non-fault condition by taking off the specific signal processor and inserting the spare signal processor.

### BACKGROUND OF THE INVENTION

1. Field of the Invention

The present invention relates to a digital signal transmission device used for the transmission of a digital signal, and more particularly to a digital signal transmission device in which signal processing is performed for a plurality of digital signals (or a primary group of digital signals) time-divided and multiplexed with each other and the digital signals are transmitted.

2. Description of Related Art

In general, in cases where a plurality of digital signals time-divided and multiplexed with each other as a primary group digital signal are transmitted, signal processing is performed for each digital signal, or for the digital signal of each communication channel (or each channel). A transmission device used for the transmission of the primary group digital signal is called a primary group digital signal transmission device. In the primary group digital signal transmission device, a signal processor is arranged for each communication channel, and the signal processing for one digital signal corresponding to one communication channel is performed in each signal processor. For making provision against a fault occurring in one signal processor in the primary group digital signal transmission device, a spare system (or a redundancy system) is arranged in addition to a currently-used system (or a main system) in the primary group digital signal transmission device. When a fault occurs in one signal processor of the main system, a system currently-used is switched from the main system to the redundancy system.

FIG. 3 is a block diagram of a conventional primary group digital signal transmission device. In FIG. 3, 10 indicates a main system. 20 indicates a redundancy system. 30 indicates a system redundancy control unit. The main system 10 is composed of a primary group interface unit 11, an input signal selecting unit 12, a plurality of signal processors 13-1 to 13-n (or a reference numeral 13 is sometimes used, and “n” denotes an integral number higher than unity), an output signal multiplexing unit 14, a primary group interface unit 15, a system monitoring and controlling unit 16 and a selecting unit 17. The redundancy system 20 is composed of a primary group interface unit 21, an input signal selecting unit 22, a plurality of signal processors 23-1 to 23-n (or 23), an output signal multiplexing unit 24, a primary group interface unit 25 and a system monitoring and controlling unit 26. The system redundancy control unit 30 has a condition comparison and output signal control unit 31.

An input-end communication line 40 is connected with both the main system 10 and the redundancy system 20, and an output-end communication line 41 is connected with the main system 10. An output of the primary group interface unit 25 is received in the selecting unit 17 of the main system 10.

In the system redundancy control unit 30, a notice of alarm occurrence sent from the system monitoring and controlling unit 16 or 26 is received in the condition comparison and output signal control unit 31, the selecting unit 17 is controlled by the condition comparison and output signal control unit 31 according to the notice of alarm occurrence to connect the primary group interface unit 15 or 25 with the output-end communication line 41.

The input-end communication line 40 and the output-end communication line 41 are respectively formed of an E1 line or a T1 line. A channel capacity of the E1 line is equal to 2.048 Mbits/second (Mbps), and the E1 line has thirty-two channels respectively having a channel capacity of 64 Kbps. In contrast, a channel capacity of the T1 line is equal to 1.544 Mbits/second (Mbps), and the T1 line has twenty-four channels respectively having a channel capacity of 64 Kbps. Each signal processor 13-i and each signal processor 23-i (“i” denotes an arbitrary integral number equal to or higher than 1) are respectively assigned to one channel, and a plurality of digital signals corresponding to a plurality of channels are transmitted through the input-end communication line 40 as a primary group digital signal and are processed in the signal processors 13-1 to 13-n or the signal processors 23-1 to 23-n.

Next, an operation of the conventional primary group digital signal transmission device will be described below.

In cases where no fault occurs in each of the signal processors 13-1 to 13-n of the main system 10, the selecting unit 17 connects the primary group interface unit 15 and the output-end communication line 41 under the control of the condition comparison and output signal control unit 31. When a primary group digital signal (or a pulse code modulation (PCM) signal) sent through the input-end communication line 40 is received in the primary group interface unit 11 of the main system 10, the primary group digital signal is input to the input signal selecting unit 12. In the input signal selecting unit 12, a plurality of digital signals of the primary group digital signal are sent to the signal processors 13-1 to 13-n corresponding to a plurality of channels respectively under the control of the system monitoring and controlling unit 16. In detail, the primary group digital signal is demultiplexed to a first digital signal, a second digital signal,—and an n-th digital signal (hereinafter, called first to n-th digital signals) in the input signal selecting unit 12, and each digital signal corresponding to one channel is sent to the signal processor 13 assigned to the channel.

In each signal processor 13 corresponding to one channel, a type of signal processing predetermined in correspondence to the channel (that is, in correspondence to a type of the corresponding digital signal) is performed for the corresponding digital signal. Therefore, a plurality of first to n-th processed digital signals are output from the signal processors 13-1 to 13-n. Thereafter, the first to n-th processed digital signals are multiplexed with each other in the output signal multiplexing unit 14 to obtain a primary group processed digital signal. Thereafter, the primary group processed digital signal is sent out to the output-end communication line 41 through the primary group interface unit 15 and the selecting unit 17.

In the system monitoring and controlling unit 16, conditions of the signal processors 13-1 to 13-n are always monitored. When a fault occurs in one of the signal processors 13-1 to 13-n, information of device alarm is sent from the signal processor corresponding to the fault and is received in the system monitoring and controlling unit 16. In the system monitoring and controlling unit 16, it is judged according to the information of device alarm that a fault occurs in one of the signal processors 13-1 to 13-n. Therefore, a notice of alarm occurrence is sent from the system monitoring and controlling unit 16 to the system redundancy control unit 30. In the system redundancy control unit 30, it is recognized according to the notice of alarm occurrence that a fault occurs in one of the signal processors 13-1 to 13-n of the main system 10. Thereafter, the selecting unit 17 switches a communication route (or a data transmission route) from the main system 10 to the redundancy system 20 under the control of the condition comparison and output signal control unit 31. Therefore, the primary group interface unit 25 of the redundancy system 20 is selected in the selecting unit 17, and the primary group digital signal sent through the input-end communication line 40 is processed in the redundancy system 20.

In the redundancy system 20, the primary group interface unit 21, the input signal selecting unit 22, the signal processors 23-1 to 23-n, the output signal multiplexing units 24, the primary group interface unit 25 and the system monitoring and controlling unit 26 are operated in the same manner as in the primary group interface unit 11, the input signal selecting unit 12, the signal processors 13-1 to 13-n, the output signal multiplexing units 14, the primary group interface unit 15 and the system monitoring and controlling unit 16. Therefore, the description of an operation of the redundancy system 20 is omitted.

Thereafter, a primary group processed digital signal obtained in the redundancy system 20 is sent out to the output-end communication line 41 through the primary group interface unit 25 and the selecting unit 17. Also, in the main system 10, the signal processor corresponding to the occurrence of the fault is repaired or exchanged for another processing unit. Therefore, the main system 10 returns to a non-fault condition. Thereafter, an operator switches the communication route from the redundancy system 20 to the main system 10 by hand.

As is described above, when a fault occurs in one of the signal processors 13-1 to 13-n of the main system 10, the switching from the main system 10 to the redundancy system 20 is performed. Therefore, it is required to arrange two systems (the main system 10 and the redundancy system 20) in the conventional primary group digital signal transmission device shown in FIG. 3, and a problem has arisen that a manufacturing cost of the primary group digital signal transmission device is heightened. Also, because the system redundancy control unit 30 is additionally needed to control the switching from the main system 10 to the redundancy system 20, a problem has arisen that the manufacturing cost of the primary group digital signal transmission device is further heightened.

To avoid these problems, a communication processor disclosed in Published Unexamined Japanese Patent Application No. H5-20237 of 1993 is, for example, known. In this Application No. H5-20237, a channel-corresponding processor currently used is arranged for each channel, and transmission control of each channel-corresponding processor is executed on a corresponding channel. Also, channel-corresponding processors of a stand-by system are additionally arranged. When it is judged in a resource managing processor that a fault is generated in one channel-corresponding processor currently used, the resource managing processor controls one channel-corresponding processor of the stand-by system to execute transmission control executed by the currently-used channel-corresponding processor generating the fault.

Therefore, because the conventional primary group digital signal transmission device shown in FIG. 3 has the above-described configuration, it is required to arrange two systems (the main system 10 and the redundancy system 20) in the conventional primary group digital signal transmission device, and a problem has arisen that a manufacturing cost of the primary group digital signal transmission device is heightened.

In contrast, in the communication processor disclosed in the Published Unexamined Japanese Patent Application No. H5-20237, the channel-corresponding processors of the stand-by system are arranged in addition to the channel-corresponding processors currently used. When a fault is generated in one channel-corresponding processor currently used, transmission control planned to be executed by the currently-used channel-corresponding processor generating the fault is executed in one channel-corresponding processor of the stand-by system in place of the currently-used channel-corresponding processor. Therefore, the channel-corresponding processor of the stand-by system is used as one currently-used channel-corresponding processor. However, in cases where the channel-corresponding processors of the stand-by system are disposed on a substrate on which the currently-used channel-corresponding processors are disposed, when the communication processor is repaired so as to return to the non-fault condition, it is required to exchange currently-used channel-corresponding processors and stand-by system channel-corresponding processors respectively not generating a fault for other new processors in addition to the currently-used channel-corresponding processor generating the fault. Therefore, a problem has arisen that a repairing cost of the communication processor is heightened. Also, even though the channel-corresponding processors of the stand-by system are disposed on a substrate different from that on which the currently-used channel-corresponding processors are disposed, other currently-used channel-corresponding processors disposed on the same substrate as that of the currently-used channel-corresponding processor generating a fault are undesirably discarded. Therefore, a problem has arisen that a repairing cost of the communication processor is heightened. Also, even though only the currently-used channel-corresponding processor generating a fault is exchanged for another new processor, a problem has arisen that the repairing work is very difficult.

### SUMMARY OF THE INVENTION

An object of the present invention is to provide, with due consideration to the drawbacks of the conventional primary group digital signal transmission device, a digital signal transmission device which is easily repaired or returns to a non-fault condition at a low cost even though a fault occurs.

The object is achieved by the provision of a digital signal transmission device which includes a plurality of signal processors corresponding to a plurality of channels respectively and arranged on substrates different from each other and a spare signal processor arranged on a substrate different from the substrates of the signal processors.

A primary group digital signal obtained by multiplexing a plurality of digital signals of the channels with each other is received, a type of predetermined signal processing is performed in each signal processor for the corresponding digital signal obtained from the primary group digital signal, and a plurality of processed digital signals are produced in the signal processors. Thereafter, a primary group processed digital signal obtained from the processed digital signals is sent out.

The digital signal transmission device further includes switching control means for switching one signal processor for the spare signal processor, in a case where the signal processor is set to a fault condition due to the occurrence of a fault, and controlling the spare signal processor to perform the same type of predetermined signal processing as that performed by the signal processor of the fault condition for the digital signal to be processed by the signal processor of the fault condition.

Therefore, it is not required to arrange two systems such as a main system and a redundancy system, and the digital signal transmission device can be manufactured at low cost.

Also, because the signal processors and the spare signal processor are arranged on the substrates different from each other, when the switching from the signal processor of a fault condition to the spare signal processor is performed, the signal processor of a fault condition is merely taken off from the digital signal transmission device, and the spare signal processor of a non-fault condition is merely inserted into the digital signal transmission device. Therefore, the switching from the signal processor of a fault condition to the spare signal processor can be easily performed, and the digital signal transmission device can easily return to a non-fault condition.

### BRIEF DESCRIPTION OF THE DRAWINGS

FIG. 1 is a block diagram of a digital signal transmission device according to a first embodiment of the present invention;

FIG. 2 is a block diagram of a signal processor shown in FIG. 1 as an example; and

FIG. 3 is a block diagram of a conventional primary group digital signal transmission device.

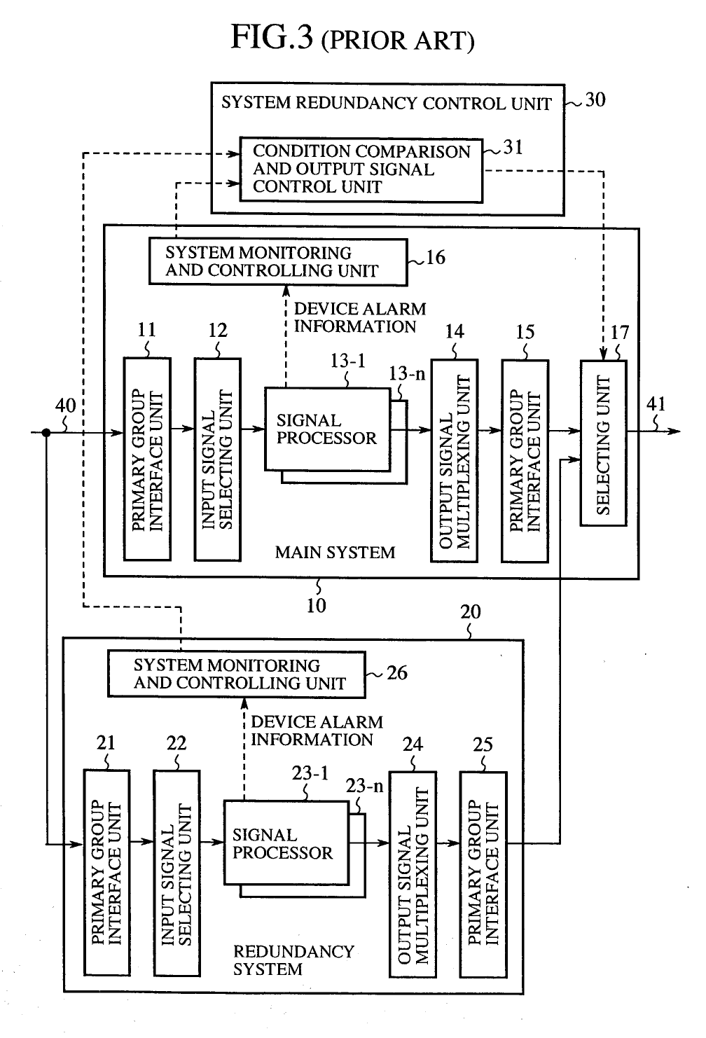

### DETAILED DESCRIPTION OF THE PREFERRED EMBODIMENTS

Embodiments of the present invention will now be described with reference to the accompanying drawings.

Embodiment 1

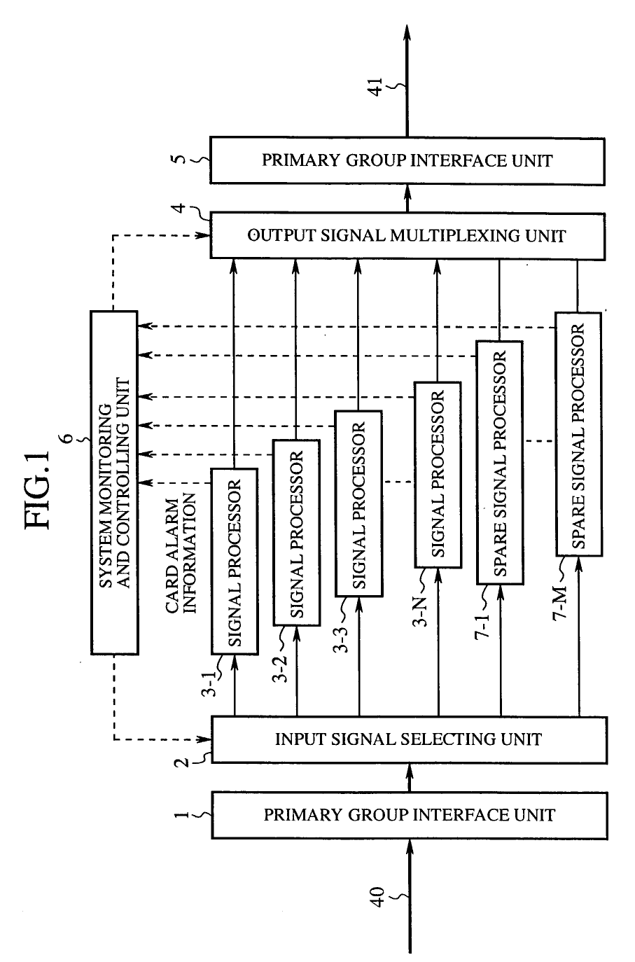

FIG. 1 is a block diagram showing the configuration of a digital signal transmission device according to a first embodiment of the present invention. In FIG. 1, 1 indicates a primary group interface unit. 2 indicates an input signal selecting unit (or selecting means). 3-1 to 3-N (or a reference numeral 3 is sometimes used, and “N” denotes an integral number higher than 1) indicate a plurality of signal processors respectively. 4 indicates an output signal multiplexing unit (or multiplexing means). 5 indicates a primary group interface unit. 6 indicates a system monitoring and controlling unit (or monitoring and controlling means). 7-1 to 7-M (or a reference numeral 7 is sometimes used, and “M” is an integral number higher than 1) indicate a plurality of spare signal processors respectively.

The signal processors 3-1 to 3-N and the spare signal processors 7-1 to 7-M are respectively disposed on a plurality of substrates different from each other. For example, each processor 3 or 7 with the substrate is formed of a card. A plurality of channels are assigned to the signal processors 3-1 to 3-N respectively, each signal processor 3 or 7 is connected with a transmission line of the corresponding channel, and a type of signal processing predetermined for each channel (or for each digital signal corresponding to one channel) is performed in the corresponding signal processor 3. For example, the signal processors 3-1 to 3-N correspond to a plurality of channels designated by channel numbers #1 to #N respectively. Also, each spare signal processor 7 has a function for performing signal processing. In cases where a fault occurs in one of the signal processors 3-1 to 3-N, the signal processor 3 having the fault is exchanged for one of the spare signal processors 7-1 to 7-M.

The input-end communication line 40 is connected with the primary group interface unit 1, and the output-end communication line 41 is connected with the primary group interface unit 5. A primary group digital signal sent through the input-end communication line 40 is processed in the digital signal transmission device, and a primary group processed digital signal is output from the digital signal transmission device to the output-end communication line 41. Here, as is described in the prior art, the input-end communication line 40 and the output-end communication line 41 are respectively formed of the E1 line or the T1 line.

Next, an operation of the digital signal transmission device will be described below.

A primary group digital signal (or a PCM signal) sent through the input-end communication line 40 is received in the input signal selecting unit 2 through the primary group interface unit 1. In the input signal selecting unit 2, a plurality of digital signals of the primary group digital signal are sent to the signal processors 3-1 to 3-N corresponding to the channels respectively under the control of the system monitoring and controlling unit 6. In detail, the primary group digital signal is demultiplexed to a first digital signal, a second digital signal, - - - and an N-th digital signal (hereinafter, called first to N-th digital signals) in the input signal selecting unit 12, and each of the first to N-th digital signals is sent to the corresponding signal processor 3 of one channel.

In each signal processor 3 of one channel, a type of predetermined signal processing is performed for the corresponding digital signal according to a type of the digital signal, and a plurality of first to N-th processed digital signals are output from the signal processors 3-1 to 3-N. In detail, various types of signal processing such as signal detection, signal identification, coding processing, facsimile demodulation and re-modulation, demodulation and re-modulation for voice-band data, echo canceling, level measurement of background noise, noise canceling, signaling detection and signaling processing are selectively performed for the first to N-th digital signals (or the PCM signals) in the signal processors 3-1 to 3-N.

A case where coding processing is performed in the signal processors 3-1 to 3-N will be described below. In a signal processor 3-k (k denotes an arbitrary integral number ranging from 1 to N), a k-th PCM signal sent through a k-th transmission line of a k-th channel is received. A data transfer rate of the k-th PCM signal is, for example, 64 Kbps. The k-th PCM signal of 64 Kbps is coded in the signal processor 3-k to an adaptive differential pulse-code modulation (ADPCM) signal (or a coded signal) having a data transfer rate of 32 Kbps.

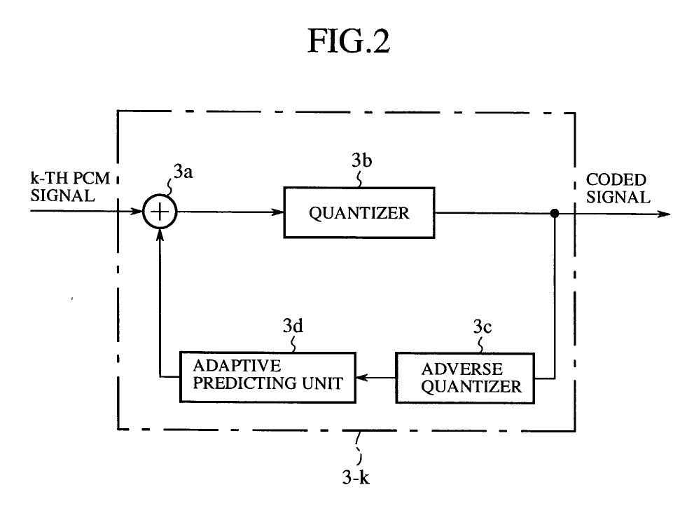

FIG. 2 is a block diagram of the k-th signal processor 3-k shown in FIG. 1.

As shown in FIG. 2, the k-th signal processor 3-k comprises an adder 3a, a quantizer 3b, an adverse quantizer 3c and an adaptive predicting unit 3d. Therefore, the ADPCM coding processing is performed for the k-th PCM signal in the k-th signal processor 3-k to produce a coded signal (or a k-th processed digital signal), and the coded signal is output to the output signal multiplexing unit 4. The ADPCM coding processing denotes a signal processing algorithm recommended by G.726 of International Telecommunications Union-Telecommunication Standardization Sector (ITU-TSS). Here, it is applicable that a data transfer rate of the coded signal be set to 16 Kbps by using a low-delay code excited linear prediction (LD-CELP) algorithm for the coding processing.

Also, signal detection, signal identification, facsimile demodulation and re-modulation, demodulation and re-modulation for voice-band data, echo canceling, level measurement of background noise, noise canceling, signaling detection and signaling processing may be performed for the k-th PCM signal in the k-th signal processor 3-k. In detail, the k-th PCM signal is detected in the k-th signal processor 3-k, and a type of the k-th PCM signal is identified according to the processing of the signal identification. Thereafter, a type of prescribed processing predetermined in correspondence to the identified type is performed for the k-th PCM signal. For example, in cases where the k-th PCM signal is a type of facsimile signal, facsimile demodulation and re-modulation is performed for the k-th PCM signal. Therefore, the k-th PCM signal can be converted into a signal having a low data transfer rate, and the signal of a low data transfer rate can be transmitted. Also, in cases where the k-th PCM signal is a type of voice signal, demodulation and re-modulation for voice-band data is performed for the k-th PCM signal. If necessary, echo canceling and noise canceling are performed for the k-th PCM signal demodulated and re-modulated. Thereafter, in cases where the k-th PCM signal denotes a voiced sound, the k-th PCM signal is transmitted. In contrast, in cases where the k-th PCM signal denotes a voiceless sound, because the transmission of the k-th PCM signal to a receiving end of a communication device denotes the transmission of no voice to the receiving end of the communication device, a person on the receiving end feels unnaturally unless noise is inserted into the k-th PCM signal denoting a voiceless sound. Therefore, noise is generally inserted into the k-th PCM signal on the receiving end of the communication device. In this embodiment, a background noise level is measured in the k-th signal processor 3-k, code information denoting the background noise level is sent with the k-th PCM signal to the receiving end of the communication device, and noise is inserted into the k-th PCM signal according to the code information on the receiving end of the communication device. In addition, in the k-th signal processor 3-k, signaling detection is performed for the k-th PCM signal (signaling processing), and it is judged according to a result of the signaling detection whether or not it is required to perform compression processing for the k-th PCM signal. If necessary, the compression processing is performed for the k-th PCM signal.

Therefore, as is described above, the signal processing is performed for the first to N-th digital signals in the signal processors 3-1 to 3-N to produce the first to N-th processed digital signals. Thereafter, the first to Nth processed digital signals are multiplexed in the output signal multiplexing unit 4 to produce a primary group processed digital signal. Thereafter, the primary group processed digital signal is sent out to the output-end communication line 41 through the primary group interface unit 5.

Also, conditions of the signal processors 3-1 to 3-N and the spare signal processors 7-1 to 7-N are always monitored in the system monitoring and controlling unit 6. When a fault occurs in one of the signal processors 3-1 to 3-N or in one of the spare signal processors 7-1 to 7-N, card alarm information is sent out from one signal processor 3 or one spare signal processor 7 set to a fault condition to the system monitoring and controlling unit 6. In detail, watch dog timer (WDT) pulses are sent out in a prescribed cycle from each signal processor 3 and each spare signal processor 7 to the system monitoring and controlling unit 6, and the WDT pulses sent from the signal processors 3-1 to 3-N and the spare signal processors 7-1 to 7-N are monitored as card information in the system monitoring and controlling unit 6. In cases where a cycle of the WDT pulses sent out from one signal processor 3 or one spare signal processor 7 does not agree with the prescribed cycle, the card information is recognized as card alarm information in the system monitoring and controlling unit 6, and it is judged in the system monitoring and controlling unit 6 that the signal processor 3 or the spare signal processor 7 is set to an alarm condition (or a fault condition).

In the system monitoring and controlling unit 6, a management table (not shown) is arranged to manage the signal processors 3-1 to 3-N and the spare signal processors 7-1 to 7-N. In detail, an identifier is used in the management table to identify each processor as a signal processor 3 or a spare signal processor 7. For example, a flag is set for each signal processor 3 or 7 currently used, and no flag is set for each signal processor 3 or 7 not currently used. Also, a channel number is attached to the flag to identify a channel corresponding to each signal processor 3 or 7 currently used. In this embodiment, because the signal processors 3-1 to 3-N are currently used, flags are set in the management table for the signal processors 3-1 to 3-N respectively, and the channel numbers #1 to #N are attached to the flags in the management table.

For example, in the system monitoring and controlling unit 6, when it is judged according to the card alarm information that the signal processor 3-1 is set to an alarm condition, one spare signal processor not set to an alarm condition is selected from the spare signal processors 7-1 to 7-N, and the selected spare signal processor is set as a signal processor currently used in place of the signal processor 3-1 having a fault. For example, the spare signal processor 7-1 not set to an alarm condition is selected as a signal processor currently used. In this embodiment, to switch the signal processor 3-1 for the spare signal processor 7-1, a card of the signal processor 3-1 is taken off from the digital signal transmission device, and a card of the spare signal processor 7-1 is inserted into the digital signal transmission device. Therefore, a switching operation can be easily performed.

In correspondence to the switching from the signal processor 3-1 to the spare signal processor 7-1, the management table is automatically renewed in the system monitoring and controlling unit 6. In detail, the flag set for the signal processor 3-1 is deleted from the management table, a flag is set in the management table for the spare signal processor 7-1, and a channel number #1 is attached to the flag of the spare signal processor 7-1.

Thereafter, a data transmission line corresponding to the channel indicated by the channel number #1 is connected with the spare signal processor 7-1 by the input signal selecting unit 2 under the control of the system monitoring and controlling unit 6, and the system monitoring and controlling unit 6 controls the output signal multiplexing unit 4 to select a first processed digital signal produced in the spare signal processor 7-1 in place of a signal produced in the signal processor 3-1.

Therefore, even though a fault occurs in the signal processor 3-1, the first digital signal initially planned to be processed in the signal processor 3-1 corresponding to the channel of the channel number #1 is sent to the spare signal processor 7-1 not set to an alarm condition, the first digital signal is processed in the spare signal processor 7-1 corresponding to the channel of the channel number #1 to produce the first processed digital signal, and the first processed digital signal is sent from the spare signal processor 7-1 to the output signal multiplexing unit 4.

In this case, the input signal selecting unit 2, the output signal multiplexing unit 4 and the system monitoring and controlling unit 6 functions as a switching control means for switching one signal processor 3 set to an alarm condition for one spare signal processor 7 not set to an alarm condition.

Therefore, when a signal processor 3-k currently used is set to an alarm condition, a spare signal processor 7-p (“p” denotes an integral number ranging from 1 to M) not set to an alarm condition is selected, and the signal processor 3-k is switched for the spare signal processor 7-p. Accordingly, even though a fault occurs in the signal processor 3-k currently used, because the switching control is performed for each signal processor, it is not required to arrange two systems (the main system 10 and the redundancy system 20) of the prior art in the digital signal transmission device, and the digital signal transmission device can be manufactured at low cost. Here, in cases where the spare signal processor 7-p currently used is set to an alarm condition, another spare signal processor 7-q (“q” denotes an integral number ranging from 1 to M and differs from “p”) not set to an alarm condition is selected, and the spare signal processor 7-p is switched for the spare signal processor 7-q in the same manner.

Also, because the signal processors 3-1 to 3-N and the spare signal processors 7-1 to 7-M are formed of cards respectively so as to be disposed on substrates different from each other, in cases where a signal processor 3 or a spare signal processor 7 set to an alarm condition (or a fault condition) due to the occurrence of a fault is switched for another spare signal processor 7 not set to an alarm condition to make the digital signal transmission device return to a non-fault condition, a card indicating the signal processor 3 or the spare signal processor 7 set to an alarm condition is merely taken off from the digital signal transmission device, and a card indicating the spare signal processor 7 not set to an alarm condition is merely inserted into the digital signal transmission device. Accordingly, because the switching operation can be performed by switching one card for another card, a signal processor 3 or a spare signal processor 7 set to an alarm condition can be easily switched for another spare signal processor 7 not set to an alarm condition, and the digital signal transmission device can reliably return to a non-fault condition.

As is described above, in the first embodiment, the digital signal transmission device comprises the signal processors 3-1 to 3-N, the spare signal processors 7-1 to 7-N, the input signal selecting unit 2, the output signal multiplexing unit 4 and the system monitoring and controlling unit 6, and the switching control is performed for each signal processor 3 and for each spare signal processor 7 by switching one signal processor 3 or one spare signal processor 7 set to an alarm condition for one spare signal processor 7 not set to an alarm condition. Therefore, it is not required to arrange two systems (the main system 10 and the redundancy system 20) of the prior art in the digital signal transmission device, and the digital signal transmission device can be manufactured at low cost.

Also, in the first embodiment, because the signal processors 3-1 to 3-N and the spare signal processors 7-1 to 7-M are formed of cards respectively so as to be disposed on substrates different from each other, in cases where one signal processor 3 or one spare signal processor 7 set to an alarm condition due to the occurrence of a fault is switched for one spare signal processor 7 not set to an alarm condition, a card indicating the signal processor 3 or the spare signal processor 7 set to an alarm condition is merely taken off from the digital signal transmission device, and a card indicating the spare signal processor 7 not set to an alarm condition is merely inserted into the digital signal transmission device. Accordingly, because the switching operation can be performed by switching one card for another card, the signal processor 3 or the spare signal processor 7 set to an alarm condition can be easily switched for the spare signal processor 7 not set to an alarm condition, and the digital signal transmission device can reliably return to a non-fault condition.

What is claimed is:

1. A digital signal transmission device, in which a primary group digital signal obtained by multiplexing a plurality of digital signals of a plurality of channels with each other is received and a plurality of processed digital signals obtained from the primary group digital signal is sent out as a primary group processed digital signal, comprising:
a plurality of signal processors, corresponding to the channels respectively and arranged on substrates different from each other, for respectively performing a type of predetermined signal processing for the corresponding digital signal obtained from the primary group digital signal and producing the processed digital signals;
a spare signal processor, arranged on a substrate different from the substrates of the signal processors, for performing signal processing for an input signal; and
switching control means for switching one signal processor for the spare signal processor, in a case where the signal processor is set to a fault condition due to the occurrence of a fault, and controlling the spare signal processor to perform the same type of predetermined signal processing as that performed by the signal processor of the fault condition for the digital signal to be processed by the signal processor of the fault condition.

2. A digital signal transmission device according to claim 1, wherein each signal processor with the substrate is formed of a card, and the spare signal processor with the substrate is formed of a card.

3. A digital signal transmission device according to claim 1, wherein the switching control means comprises:
selecting means for receiving the primary group digital signal and providing each digital signal of the primary group digital signal to the corresponding signal processor;
multiplexing means for receiving the processed digital signals from the signal processors, multiplexing the processed digital signals to produce the primary group processed digital signal and sending out the primary group processed digital signal; and
monitoring and controlling means for monitoring the signal processors, detecting the signal processor set to the fault condition and controlling the selecting means and the multiplexing means to currently use the spare signal processor in place of the signal processor set to the fault condition.

4. A digital signal transmission device according to claim 3, wherein the monitoring and controlling means controls the selecting means to connect a transmission line of the channel corresponding to the signal processor of the fault condition and the spare signal processor, and the monitoring and controlling means controls the multiplexing means to receive the processed digital signal produced by the spare the signal processor in place of that produced by the signal processor of the fault condition.

5. A digital signal transmission device according to claim 1, further comprising
another spare signal processor or a plurality of other spare signal processors, arranged on a substrate or a plurality of substrates, for respectively performing signal processing for an input signal,
wherein the substrates of the signal processors and the spare signal processors differ from each other, and the switching control means comprises:
selecting means for receiving the primary group digital signal and providing each digital signal of the primary group digital signal to the corresponding signal processor;
multiplexing means for receiving the processed digital signals from the signal processors, multiplexing the processed digital signals to produce the primary group processed digital signal and sending out the primary group processed digital signal; and
monitoring and controlling means for monitoring the signal processors and the spare signal processors, detecting the signal processor set to the fault condition, selecting one spare signal processor not set to a fault condition, and controlling the selecting means and the multiplexing means to currently use the spare signal processor not set to the fault condition in place of the signal processor set to the fault condition.

6. A digital signal transmission device according to claim 5, wherein the monitoring and controlling means controls the selecting means to connect a transmission line of the channel corresponding to the signal processor of the fault condition and the spare signal processor not set to the fault condition, and the monitoring and controlling means controls the multiplexing means to receive the processed digital signal produced by the spare the signal processor not set to the fault condition in place of that produced by the signal processor of the fault condition.
